(19) United States
(12) Patent Application Publication
(10) Pub. No.: US 2025/0208561 A1
(43) Pub. Date: Jun. 26, 2025

(54) IMAGE FORMING APPARATUS

(71) Applicant: KYOCERA Document Solutions Inc., Osaka (JP)

(72) Inventors: Keiju Ishida, Osaka (JP); Takehiro Sato, Osaka (JP); Sachio Izumichi, Osaka (JP)

(21) Appl. No.: 18/990,089

(22) Filed: Dec. 20, 2024

(30) Foreign Application Priority Data
Dec. 25, 2023 (JP) 2023-217705

(51) Int. Cl. G03G 21/16; G03G 15/00; G03G 15/20

(52) U.S. Cl. CPC G03G 21/1633; G03G 15/2064; G03G 15/6579; G03G 15/80; G03G 21/1619; G03G 21/1647; G03G 21/1652

(57) ABSTRACT

A main body includes a first opening and a second opening. A first cover member is capable of opening and closing the first opening. A second cover member is capable of opening and closing the second opening. At least a part of a fixing device can be drawn out from the main body via the second opening. A latch mechanism latches the second cover member at a closing position. A release mechanism is arranged at a position that can be accessed from the first opening in the main body and releases the latch of the second cover member by the latch mechanism upon receiving an external force.

### INCORPORATION BY REFERENCE

This application is based upon and claims the benefit of priority from the corresponding Japanese Patent Application No. 2023-217705 filed on Dec. 25, 2023, the entire contents of which are incorporated herein by reference.

### BACKGROUND

The present disclosure relates to an image forming apparatus including a fixing device, at least a part of which can be drawn out from a main body.

An image forming apparatus that uses electrophotography fixes a toner image onto a sheet using a fixing device.

The fixing device may be sectioned into a fixing unit which includes a fixing member and a pressure roller and a heating unit which includes a heater for heating the fixing member.

Further, the image forming apparatus is known to include a mechanism for moving the heating unit from a heating position to an evacuation position in an interlocking manner with an operation with respect to an operation member. The fixing unit can be drawn out from the main body while the heating unit is evacuated to the evacuation position.

### SUMMARY

An image forming apparatus according to an aspect of the present disclosure includes a main body, a sheet conveying path, a first cover member, a second cover member, a fixing device, a latch mechanism, and a release mechanism. The main body includes a first opening and a second opening formed in a direction different from that of the first opening. The sheet conveying path is arranged in the main body and passes through a specific position inside the first opening. The first cover member is capable of opening and closing the first opening and is opened to thus open a part of the sheet conveying path. The second cover member is capable of opening and closing the second opening. The fixing device is arranged at the specific position in the main body, includes a heater and a fixing member which is heated by the heater and also heats a toner image formed on a sheet that passes through the specific position, and at least a part of which can be drawn out from the main body via the second opening. The latch mechanism latches the second cover member at a closing position. The release mechanism is arranged at a position that can be accessed from the first opening in the main body and releases the latch of the second cover member by the latch mechanism upon receiving an external force.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to an embodiment;

FIG. 2 is a diagram showing a partial configuration of a fixing device in the image forming apparatus according to the embodiment;

FIG. 3 is a perspective view of a main body frame in the image forming apparatus according to the embodiment;

FIG. 4 is a front view of the fixing device in a vicinity state in the image forming apparatus according to the embodiment;

FIG. 5 is a front view of the fixing device in a spaced state in the image forming apparatus according to the embodiment;

FIG. 6 is a perspective view of a fixing unit in the image forming apparatus according to the embodiment;

FIG. 7 is a plan view of an interlocking mechanism in a biased state and a latch/release mechanism in a latched state in the image forming apparatus according to the embodiment;

FIG. 8 is a plan view of the interlocking mechanism in a pulling state and the latch/release mechanism in a released state in the image forming apparatus according to the embodiment;

FIG. 9 is a perspective view of a part of a second cover member and an elastic latch portion in the image forming apparatus according to the embodiment;

FIG. 10 is a perspective view of the latch/release mechanism in the released state in the image forming apparatus according to the embodiment; and

FIG. 11 is a perspective view of the latch/release mechanism in the latched state in the image forming apparatus according to the embodiment.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

### [Configuration of Image Forming Apparatus 10]

An image forming apparatus 10 according to the embodiment executes print processing using electrophotography. The print processing is processing of forming an image on a sheet.

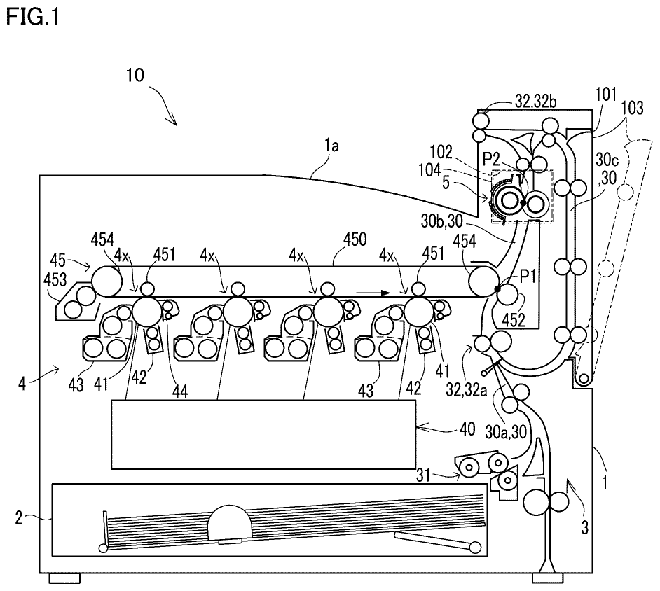

As shown in FIG. 1, the image forming apparatus 10 includes a sheet storing portion 2, a sheet conveying path 30, a sheet conveying device 3, and a printing device 4. The sheet conveying device 3 and the printing device 4 are housed in a main body 1 as a housing. The main body 1 includes a main body frame 1x that constitutes a framework of the main body 1 and an exterior member attached to the main body frame 1x.

The sheet storing portion 2 is capable of storing the sheets. The sheet conveying path 30 is a path of the sheets that is arranged inside the main body 1. The sheet conveying device 3 includes a sheet feed device 31 and a plurality of conveying roller pairs 32.

The sheet feed device 31 feeds the sheets stored in the sheet storing portion 2 one by one to the sheet conveying path 30. The sheet conveying path 30 is arranged along a path that passes through a transfer position P1 and a fixing position P2 in the main body 1.

The plurality of conveying roller pairs 32 convey the sheet along the sheet conveying path 30. The plurality of conveying roller pairs 32 include a registration roller pair 32a and a discharge roller pair 32b.

The registration roller pair 32a temporarily stops the conveyance of the sheet and adjusts a timing at which the sheet is to be fed to the transfer position P1. The discharge roller pair 32b discharges the sheet on which an image has been formed onto a discharge tray 1a from the sheet conveying path 30.

The sheet conveying path 30 includes a first conveying path 30a, a second conveying path 30b, and a third conveying path 30c (see FIG. 1).

The first conveying path 30a is a path that is provided from a position of the sheet feed device 31 to a position before the registration roller pair 32a.

The second conveying path 30b is a path that is continuous with the first conveying path 30a and includes a position of the registration roller pair 32a, the transfer position P1, the fixing position P2, and a position of the discharge roller pair 32b.

The third conveying path 30c is a path that branches from a portion between the fixing position P2 and the position of the discharge roller pair 32b on the second conveying path 30b and joins the second conveying path 30b at a connection portion with the first conveying path 30a.

The third conveying path 30c is a path of the sheet that is conveyed by being inverted after passing through the fixing position P2. The third conveying path 30c is a so-called inverse conveying path. When conveyed along the third conveying path 30c, the sheet is conveyed along the second conveying path 30b again in a state where the front, back, top, and bottom thereof are inverted.

The printing device 4 executes the print processing on the sheet conveyed along the second conveying path 30b. An image to be formed on the sheet is a toner image.

The printing device 4 includes a laser scanning unit 40, one or more image forming portions 4x, a transfer device 45, and a fixing device 5. The image forming portion 4x includes a photoconductor 41, a charging device 42, a developing device 43, and a drum cleaning device 44.

The charging device 42 charges a surface of the photoconductor 41. The laser scanning unit 40 scans beam light on the charged surface of the photoconductor 41. Thus, the laser scanning unit 40 forms an electrostatic latent image on the surface of the photoconductor 41.

The developing device 43 develops the electrostatic latent image formed on the surface of the photoconductor 41 into a toner image. The transfer device 45 transfers the toner image formed on the surface of the photoconductor 41 onto the sheet.

In the present embodiment, the printing device 4 is a tandem-type color printing device including a plurality of image forming portions 4x. Further, the transfer device 45 includes an intermediate transfer belt 450, a plurality of primary transfer devices 451, a secondary transfer device 452, and a belt cleaning device 453.

In the example shown in FIG. 1, the printing device 4 includes four image forming portions 4x respectively corresponding to toner of four colors, that is, yellow, magenta, cyan, and black. The transfer device 45 includes four primary transfer devices 451 respectively corresponding to the four image forming portions 4x.

The intermediate transfer belt 450 is rotatably supported by a plurality of supporting rollers 454. One of the plurality of supporting rollers 454 rotates by being driven by a belt drive device (not shown). Thus, the intermediate transfer belt 450 rotates.

Each of the primary transfer devices 451 transfers the toner image formed on the surface of the photoconductor 41 in the corresponding one of the image forming portions 4x onto a surface of the intermediate transfer belt 450. Thus, a synthetic toner image obtained by synthesizing the toner images of four colors is formed on the surface of the intermediate transfer belt 450.

The intermediate transfer belt 450 rotates while carrying the synthetic toner image. The secondary transfer device 452 transfers the synthetic toner image formed on the surface of the intermediate transfer belt 450 onto the sheet at the transfer position P1.

The drum cleaning device 44 removes waste toner from the surface of the photoconductor 41. The belt cleaning device 453 removes waste toner from the surface of the intermediate transfer belt 450.

The fixing device 5 is arranged at the fixing position P2 on the sheet conveying path 30. The fixing position P2 is a specific position inside a first opening 101. The fixing position P2 is a position on a downstream side of the transfer position P1 in a sheet conveying direction.

The fixing device 5 heats and pressurizes the synthetic toner image formed on the sheet at the fixing position P2. Thus, the fixing device 5 fixes the synthetic toner image onto the sheet.

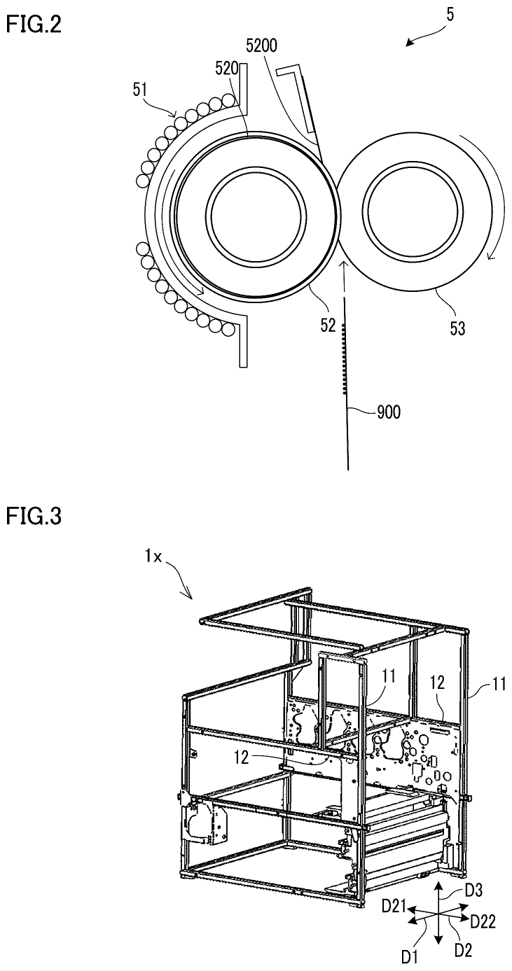

As shown in FIG. 2, the fixing device 5 includes a heater 51, a fixing belt 52, a fixing roller 520, a pressure roller 53, and a sheet separation member 5200.

The fixing belt 52 is a flexible cylindrical member including the fixing roller 520 therein. The fixing belt 52 is heated by the heater 51 and also heats the toner image formed on the sheet that passes through the fixing position P2.

The fixing roller 520 is a cylindrical member which supports the fixing belt 52 from an inner side of the fixing belt 52. The fixing roller 520 is supported rotatably. The fixing belt 52 is capable of rotating with the fixing roller 520.

The fixing belt 52 includes a conductive base material, an elastic layer formed on an outer circumference of the base material, and a release layer formed on an outer circumference of the elastic layer.

The heater 51 is arranged so as to oppose an outer circumferential surface of the fixing belt 52. In the present embodiment, the heater 51 is a heating device that uses an induction heating system. The heater 51 mainly heats the base material of the fixing belt 52 by electromagnetic induction.

The pressure roller 53 is supported rotatably. The pressure roller 53 rotates by being driven by a drive device (not shown). The fixing belt 52 and the fixing roller 520 rotate in conjunction with the pressure roller 53.

The fixing belt 52 heats the toner image formed on the sheet. The pressure roller 53 biases the sheet toward the fixing belt 52 to thus pressurize the toner image toward the sheet.

It is noted that the fixing belt 52 is an example of a fixing member that is heated by the heater 51. The pressure roller 53 is an example of a pressure member that biases the sheet toward the fixing belt 52.

The sheet separation member 5200 peels the sheet 900 off from the fixing belt 52 when the sheet adheres onto the fixing belt 52.

When the print processing is executed on one side of the sheet, the sheet conveying device 3 executes first conveyance processing, second conveyance processing, and discharge processing. The first conveyance processing is processing of conveying the sheet stored in the sheet storing portion 2 along the first conveying path 30a. The second conveyance processing is processing of conveying the sheet along the second conveying path 30b. The discharge processing is processing of discharging the sheet onto the discharge tray 1a from the second conveying path 30b.

When the print processing is executed on both sides of the sheet, the sheet conveying device 3 first executes the first conveyance processing, the second conveyance processing, and third conveyance processing and then executes the second conveyance processing and the discharge processing. The third conveyance processing is processing of inverting the sheet on the second conveying path 30b and further conveying the sheet along the third conveying path 30c.

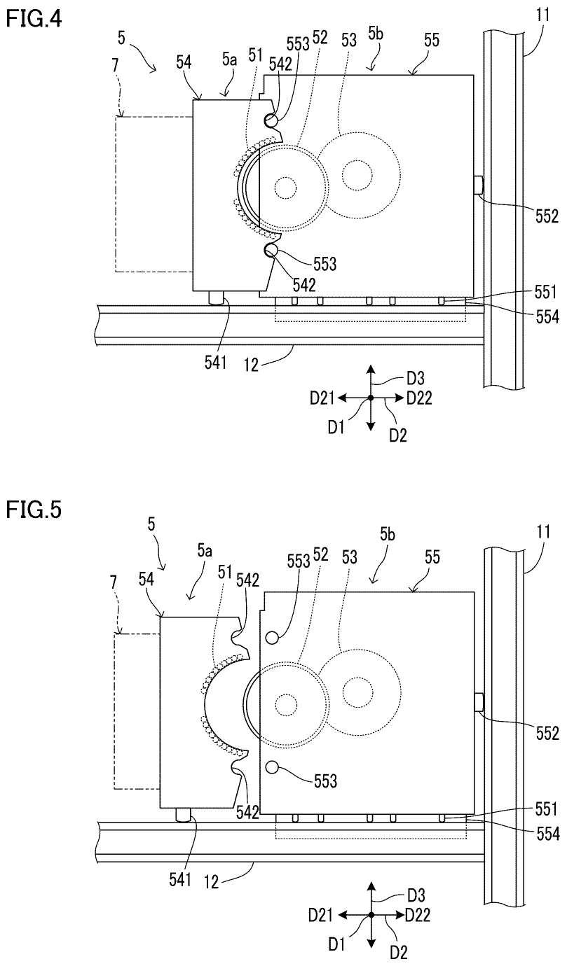

In the present embodiment, the fixing device 5 is sectioned into a heating unit 5a and a fixing unit 5b (see FIG. 4 and FIG. 5). The heating unit 5a is arranged along a first direction D1 in the main body 1. The fixing unit 5b is also arranged along the first direction D1 in the main body 1.

In other words, the heating unit 5a and the fixing unit 5b are arranged in a state where longitudinal directions thereof are provided along the first direction D1.

The heating unit 5a and the fixing unit 5b are arranged next to each other in a second direction D2. In other words, the second direction D2 is an array direction of the heating unit 5a and the fixing unit 5b. The second direction D2 is a direction that intersects with the first direction D1.

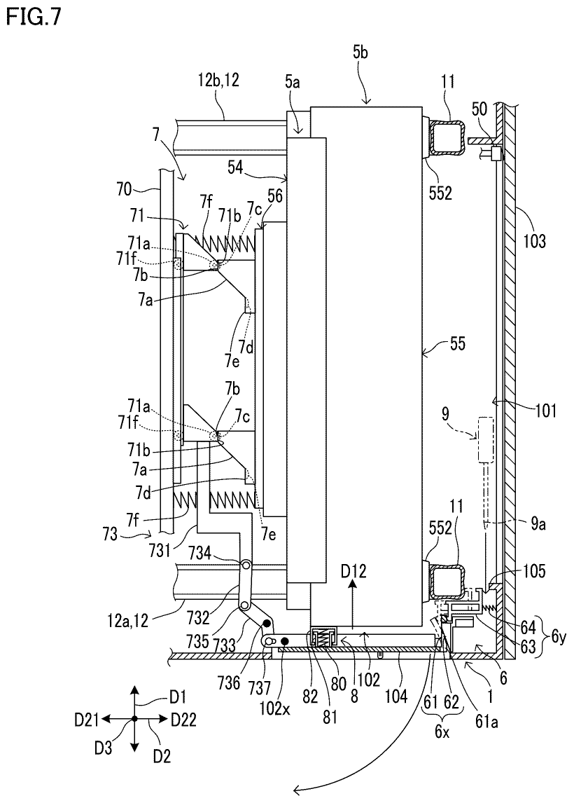

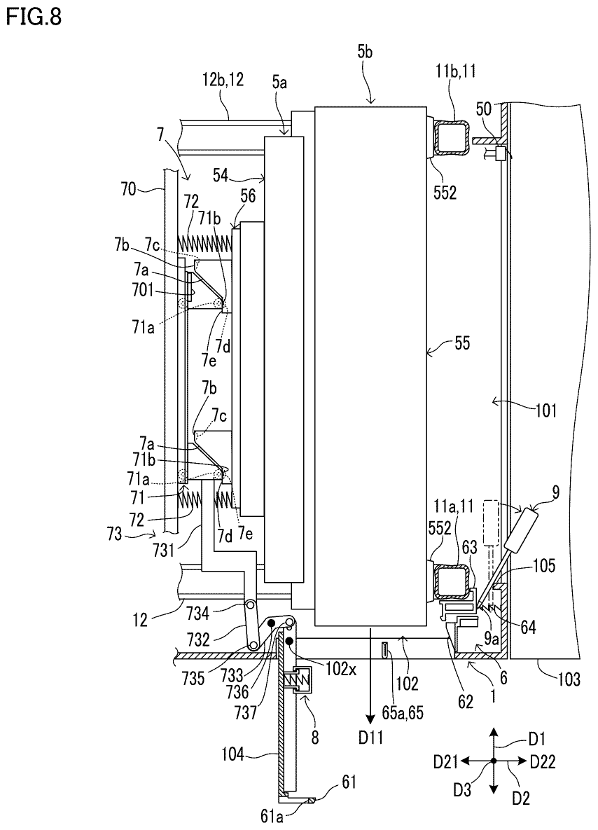

In descriptions below, one side of the second direction D2 will be referred to as a first side D21, and the other side of the second direction D2 will be referred to as a second side D22 (see FIG. 3 to FIG. 5, FIG. 7, and FIG. 8). The heating unit 5a is arranged on the first side D21 with respect to the fixing unit 5b (see FIG. 4, FIG. 5, FIG. 7, and FIG. 8).

The heating unit 5a includes the heater 51 and a first supporting member 54. The fixing unit 5b includes the fixing belt 52, the fixing roller 520, the pressure roller 53, and a second supporting member 55.

The first supporting member 54 is a member which supports the heater 51. The second supporting member 55 is a member which supports the fixing belt 52, the fixing roller 520, and the pressure roller 53. The fixing belt 52 is supported by the second supporting member 55 via the fixing roller 520.

The main body frame 1x is configured by a combination of a plurality of metal pipes (see FIG. 3). The heating unit 5a and the fixing unit 5b are supported by the main body frame 1x. The fixing unit 5b is arranged on the second side D22 of the second direction D2 with respect to the heating unit Sa.

The plurality of metal pipes configuring the main body frame 1x include restriction portions 11 and lower supporting portions 12 (see FIG. 3 to FIG. 5).

In the present embodiment, the restriction portions 11 are two supporting column pipes that are formed to extend in a longitudinal direction D3 and are arranged while being spaced apart from each other in the first direction D1 (see FIG. 3). The longitudinal direction D3 is an up-down direction.

The lower supporting portions 12 are two beam pipes that are formed to extend in the second direction D2 below the heating unit 5a and the fixing unit 5b and are arranged while being spaced apart from each other in the first direction D1 (see FIG. 3).

The heating unit 5a and the fixing unit 5b are mounted on the lower supporting portions 12 in a state where longitudinal directions thereof are provided along the first direction D1 (see FIG. 7 and FIG. 8). In other words, the lower supporting portions 12 support the heating unit 5a and the fixing unit 5b from below.

The heating unit 5a and the fixing unit 5b are movable on the lower supporting portions 12 along the second direction D2. The fixing unit 5b is arranged between the heating unit 5a and the restriction portions 11 (see FIG. 4 and FIG. 5).

By the heating unit 5a being moved to a position apart from the fixing unit 5b, the fixing unit 5b can be drawn out from the main body 1 along the first direction D1 (see FIG. 5 and FIG. 8).

The main body 1 includes the first opening 101 and a second opening 102 formed in a direction different from that of the first opening 101 (see FIG. 1, FIG. 7, and FIG. 8).

For example, the first opening 101 is formed on one of both side surfaces of the main body 1, and the second opening 102 is formed on one of a front surface and a back surface of the main body 1. Alternatively, the first opening 101 is formed on one of the front surface and the back surface of the main body 1, and the second opening 102 is formed on one of the both side surfaces of the main body 1.

In the present embodiment, the first opening 101 is formed on a side surface of the main body 1 on the second side D22 of the second direction D2, and the second opening 102 is formed on the front surface of the main body 1 (see FIG. 1).

The image forming apparatus 10 includes a first cover member 103 that is capable of opening and closing the first opening 101 and a second cover member 104 that is capable of opening and closing the second opening 102 (see FIG. 1).

By being opened, the first cover member 103 opens a part of the sheet conveying path 30 to the outside of the main body 1. In the present embodiment, the first cover member 103 is opened to thus open the third conveying path 30c to the outside of the main body 1 (see FIG. 1).

By being opened, the second cover member 104 opens one end of at least a part of the fixing device 5 in the first direction D1 to the outside of the main body 1. In the present embodiment, the second cover member 104 is opened to thus open one end of the fixing unit 5b in the first direction D1 to the outside of the main body 1 (see FIG. 8).

Incidentally, the temperature of the fixing device 5 becomes high. Therefore, it is desirable to be able to prevent the user from carelessly drawing out a part or all of the fixing device 5 from the main body 1.

The image forming apparatus 10 has a configuration for preventing the user from carelessly drawing out the fixing unit 5b from the main body 1. Hereinafter, the configuration related to the attachment and detachment of the fixing unit 5b in the image forming apparatus 10 will be described.

The second cover member 104 is supported by a first supporting shaft 102x (see FIG. 7 and FIG. 8). Thus, the second cover member 104 is rotatable about the first supporting shaft 102x. The second cover member 104 is movable between a closing position at which the second opening 102 is closed and an opening position at which the second opening 102 is opened.

FIG. 7 shows the second cover member 104 positioned at the closing position and the fixing device 5. FIG. 8 shows the second cover member 104 positioned at the opening position and the fixing device 5.

The image forming apparatus 10 further includes an interlocking mechanism 7 and a latch/release mechanism 6 (see FIG. 7 and FIG. 8). The latch/release mechanism 6 includes a latch mechanism 6x and a release mechanism 6y.

The interlocking mechanism 7 is a mechanism for causing the heating unit 5a to approach the fixing unit 5b or be spaced apart from the fixing unit 5b in an interlocking manner with a closing operation or opening operation of the second cover member 104.

The latch mechanism 6x latches the second cover member 104 to retain the second cover member 104 at the closing position (see FIG. 7). The release mechanism 6y releases the latch of the second cover member 104 by the latch mechanism 6x (see FIG. 8). By releasing the latch of the second cover member 104, the second cover member 104 can rotate from the closing position to the opening position.

When the second cover member 104 is positioned at the opening position, the fixing unit 5b can be drawn out from the main body 1 via the second opening 102 (see FIG. 8).

### [Configuration of Interlocking Mechanism 7]

The interlocking mechanism 7 moves in an interlocking manner with the second cover member 104. By being operated, the second cover member 104 can move in a closing direction or an opening direction.

The closing direction is a movement direction of the second cover member 104 when closing the second cover member 104. The opening direction is a movement direction of the second cover member 104 when opening the second cover member 104.

The interlocking mechanism 7 causes the heating unit 5a to move along the second direction D2 in an interlocking manner with the movement of the second cover member 104.

The interlocking mechanism 7 causes the heating unit 5a to move toward the second side D22 in an interlocking manner with the movement of the second cover member 104 in the closing direction (see FIG. 7). On the other hand, the interlocking mechanism 7 causes the heating unit 5a to move toward the first side D21 in an interlocking manner with the movement of the second cover member 104 in the opening direction (see FIG. 8).

The interlocking mechanism 7 includes a coupling member 56, a guide member 70, a movable member 71, bias members 72, and a first direction movement mechanism 73. The coupling member 56 is coupled to the first supporting member 54 of the heating unit 5a. The coupling member 56 configures a part of the heating unit 5a.

The bias members 72 bias the heating unit 5a toward the first side D21. Specifically, the bias members 72 are one or more elastic members that bias the heating unit 5a toward the first side D21. For example, the elastic member is a coil spring, a leaf spring, or the like.

In the examples shown in FIG. 7 and FIG. 8, the bias members 72 are two tension springs that elastically bias the heating unit 5a toward the first side D21.

The coupling member 56 includes tilted surfaces 7a. The tilted surfaces 7a are provided in the heating unit 5a while facing the first side D21. The tilted surfaces 7a are surfaces that are tilted from the second side D22 toward the first side D21 with respect to the first direction D1. In the present embodiment, the tilted surfaces 7a are provided at two positions spaced apart from each other in the first direction D1 (see FIG. 7 and FIG. 8).

The movable member 71 is supported while being movable along the first direction D1. The guide member 70 guides the movable member 71 along the first direction D1. For example, the guide member 70 is supported by the main body frame 1x.

The movable member 71 includes one or more rollers 71a that are supported rotatably (see FIG. 7 to FIG. 9). The rollers 71a are provided at positions respectively corresponding to the tilted surfaces 7a in the movable member 71. In the present embodiment, the rollers 71a are provided at two positions spaced apart from each other in the first direction D1 (see FIG. 7 to FIG. 9). The rollers 71a roll while being in contact with the tilted surfaces 7a.

The first direction movement mechanism 73 causes the movable member 71 to move along the first direction D1 in an interlocking manner with the movement of the second cover member 104. In the present embodiment, the first direction movement mechanism 73 is a link mechanism which converts the rotation of the second cover member 104 into a linear operation along the first direction D1.

The first direction movement mechanism 73 includes a first link member 731, a second link member 732, and a third link member 733 (see FIG. 7 and FIG. 8).

One end of the first link member 731 is connected to the movable member 71, and the other end of the first link member 731 is coupled to one end of the second link member 732 by a first coupling shaft 734. The other end of the second link member 732 is connected to one end of the third link member 733 by a second coupling shaft 735. The other end of the third link member 733 is coupled to one end of the second cover member 104 by a third coupling shaft 737.

The third link member 733 is rotatably supported by a second supporting shaft 736.

In the present embodiment, when moving the second cover member 104 from the opening position to the closing position, the first direction movement mechanism 73 causes the movable member 71 to move toward a rear side along the first direction D1. Moreover, when moving the second cover member 104 from the closing position to the opening position, the first direction movement mechanism 73 causes the movable member 71 to move toward a front side along the first direction D1.

As described above, the movement direction from the opening position to the closing position is the closing direction. The movement direction from the closing position to the opening position is the opening direction.

In descriptions below, an end portion of the tilted surface 7a on the second side D22 will be referred to as a base end portion of the tilted surface 7a, and an end portion of the tilted surface 7a on the first side D21 will be referred to as a terminal portion of the tilted surface 7a. The base end portion is an example of a portion of the tilted surface 7a on the second side D22. The terminal portion is an example of a portion of the tilted surface 7a on the first side D21.

When the movable member 71 moves in an interlocking manner with the movement of the second cover member 104 in the closing direction, the roller 71a rolls from the base end portion to the terminal portion on the tilted surface 7a. By rolling from the base end portion to the terminal portion on the tilted surface 7a, the roller 71a pushes the tilted surface 7a toward the second side D22. By pushing the tilted surface 7a toward the second side D22, the roller 71a causes the heating unit 5a to move toward the second side D22 against a bias force of the bias member 72.

Neither the heating unit 5a nor the fixing unit 5b is fixed to the main body frame 1x by a fixture such as a screw.

The restriction portions 11 restrict a movement range of the fixing unit 5b toward the second side D22. By the rollers 71a causing the heating unit 5a to move toward the second side D22, the fixing unit 5b and the heating unit 5a are sandwiched by the movable member 71 and the restriction portions 11 (see FIG. 4 and FIG. 7).

FIG. 7 shows the interlocking mechanism 7 in a biased state where the movable member 71 is biasing the heating unit 5a and the fixing unit 5b toward the restriction portions 11. FIG. 4 and FIG. 7 each show the fixing device 5 in a vicinity state where the heating unit 5a is retained in the vicinity of the fixing unit 5b by the interlocking mechanism 7.

By being sandwiched between the movable member 71 and the restriction portions 11, the fixing unit 5b and the heating unit 5a are positioned in the second direction D2.

In other words, when the movable member 71 moves in an interlocking manner with the movement of the second cover member 104 in the closing direction, the fixing unit 5b and the heating unit 5a are sandwiched by the movable member 71 and the restriction portions 11 to thus be positioned in the second direction D2.

The first supporting member 54 includes a plurality of concave first fitting portions 542 that are opened toward the second side D22 (see FIG. 4 and FIG. 5). The second supporting member 55 includes a plurality of convex second fitting portions 553 into which the plurality of first fitting portions 542 can be fit, respectively (see FIG. 4 and FIG. 5).

By the interlocking mechanism 7 causing the heating unit 5a to move toward the second side D22, the plurality of first fitting portions 542 and the plurality of second fitting portions 553 fit into one another (see FIG. 4).

By the fitting of the plurality of first fitting portions 542 and the plurality of second fitting portions 553, relative movements of the heating unit 5a and the fixing unit 5b in the longitudinal direction D3 are restricted.

It is noted that alternatively, the second supporting member 55 may include the plurality of first fitting portions 542, and the first supporting member 54 may include the plurality of second fitting portions 553.

Meanwhile, when the movable member 71 moves in an interlocking manner with the movement of the second cover member 104 in the opening direction, the roller 71a rolls from the terminal portion to the base end portion on the tilted surface 7a, and the bias member 72 causes the heating unit 5a to move toward the first side D21.

FIG. 8 shows the interlocking mechanism 7 in a pulling state where the bias member 72 is pulling the heating unit 5a toward the first side D21. FIG. 5 and FIG. 8 each show the fixing device 5 in a spaced state where the heating unit 5a is spaced apart from the fixing unit 5b toward the first side D21 by the interlocking mechanism 7.

In the present embodiment, the movable member 71 further includes first contact surfaces 71b (see FIG. 7 to FIG. 9). The coupling member 56 further includes second contact surfaces 7b respectively corresponding to the first contact surfaces 71b and first concave portions 7c respectively corresponding to the rollers 71a (see FIG. 7 and FIG. 8).

The first contact surfaces 71b are surfaces that face the second side D22 and are capable of coming into contact with the second contact surfaces 7b of the coupling member 56. For example, the first contact surfaces 71b are formed at three or more positions in the movable member 71.

The second contact surfaces 7b are surfaces that face the first side D21 and are capable of coming into contact with the first contact surfaces 71b of the movable member 71. The second contact surfaces 7b are formed at positions respectively corresponding to the first contact surfaces 71b in the coupling member 56.

The first concave portions 7c face the first side D21 and are each arranged next to the terminal portion of the tilted surface 7a in the first direction D1 (see FIG. 7 and FIG. 8). The first concave portions 7c are provided at positions respectively corresponding to the rollers 71a in the coupling member 56. In the present embodiment, the first concave portions 7c are provided at two positions in the coupling member 56.

A part of the roller 71a can be inserted into the first concave portion 7c. Specifically, a part of the roller 71a including an edge on the second side D22 can be inserted into the first concave portion 7c.

When the movable member 71 moves in an interlocking manner with the movement of the second cover member 104 in the closing direction, the following first operation occurs. In the first operation, after the roller 71a rolls from the base end portion to the terminal portion on the tilted surface 7a, a part of the roller 71a enters the first concave portion 7c, and the first contact surface 71b is abutted against the second contact surface 7b (see FIG. 7).

By the first contact surfaces 71b being abutted against the second contact surfaces 7b, the fixing unit 5b and the heating unit 5a are sandwiched by the movable member 71 and the restriction portions 11. Thus, the fixing unit 5b and the heating unit 5a are positioned in the second direction D2.

In general, an allowance is formed between the roller 71a and a rotation shaft of the roller 71a. The fixing unit 5b and the heating unit 5a are positioned with high accuracy by being positioned in a state where the first contact surfaces 71b and the second contact surfaces 7b are in contact with one another.

Further, when the fixing unit 5b and the heating unit 5a are positioned by the contact of the first contact surfaces 71b and the second contact surfaces 7b, a large force is not applied to the rollers 71a. Therefore, durability of the rollers 71a is improved.

On the other hand, when the movable member 71 moves in an interlocking manner with the movement of the second cover member 104 in the opening direction, the following second operation occurs. In the second operation, after the rollers 71a are detached from the first concave portions 7c and the first contact surfaces 71b are spaced apart from the second contact surfaces 7b, the rollers 71a each roll from the terminal portion to the base end portion on the tilted surface 7a (see FIG. 8).

In the present embodiment, the coupling member 56 further includes third contact surfaces 7d respectively corresponding to the first contact surfaces 71b and second concave portions 7e respectively corresponding to the rollers 71a (see FIG. 7 and FIG. 8).

The third contact surfaces 7d are surfaces that face the first side D21 and are capable of coming into contact with the first contact surfaces 71b of the movable member 71. The third contact surfaces 7d are formed at positions respectively corresponding to the first contact surfaces 71b in the coupling member 56.

The second concave portions 7e face the first side D21 and are each arranged next to the base end portion of the tilted surface 7a in the first direction D1 (see FIG. 7 and FIG. 8). The second concave portions 7e are provided at positions respectively corresponding to the rollers 71a in the coupling member 56. In the present embodiment, the second concave portions 7e are provided at two positions in the coupling member 56.

A part of the roller 71a can be inserted into the second concave portion 7e. Specifically, a part of the roller 71a including an edge on the second side D22 can be inserted into the second concave portion 7e.

When the movable member 71 moves in an interlocking manner with the movement of the second cover member 104 in the opening direction, the following third operation occurs. In the third operation, after the roller 71a is detached from the first concave portion 7c and further rolls from the terminal portion to the base end portion on the tilted surface 7a, a part of the roller 71a enters the second concave portion 7e, and the first contact surface 71b is abutted against the third contact surface 7d (see FIG. 8).

Accordingly, when the heating unit 5a is spaced apart from the fixing unit 5b toward the first side D21, a force of the bias member 72 is not applied to the roller 71a. Therefore, durability of the rollers 71a is improved.

Meanwhile, when the movable member 71 moves in an interlocking manner with the movement of the second cover member 104 in the closing direction, the following fourth operation occurs. In the fourth operation, after the roller 71a is detached from the second concave portion 7e and the first contact surface 71b is spaced apart from the third contact surface 7d, the roller 71a rolls from the base end portion to the terminal portion on the tilted surface 7a (see FIG. 7).

In the image forming apparatus 10, the heating unit 5a can smoothly approach the fixing unit 5b or be spaced apart from the fixing unit 5b by actions of the rollers 71a.

In the present embodiment, the movable member 71 further includes rollers 71f (see FIG. 7). The rollers 71f are in contact with the guide member 70. When the movable member 71 moves along the first direction D1, the rollers 71f roll on a surface of the guide member 70.

By actions of the rollers 71f, the heating unit 5a can more smoothly approach the fixing unit 5b or be spaced apart from the fixing unit 5b.

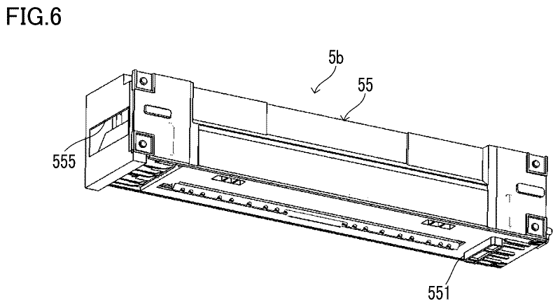

In addition, the image forming apparatus 10 further includes a first direction bias mechanism 8 that is attached to an inner surface of the second cover member 104 (see FIG. 7 and FIG. 8). Further, the second supporting member 55 of the fixing unit 5b includes protrusion portions 551 that protrude from a lower surface of the second supporting member 55 (see FIG. 4 to FIG. 6).

The first direction bias mechanism 8 includes a spring 80, a spring case 81, and a cap portion 82 (see FIG. 7).

The spring case 81 houses the spring 80. The cap portion 82 is attached while being movable with respect to the spring case 81. The spring 80 is an example of the elastic member.

When the second cover member 104 is positioned at the closing position, the spring 80 is sandwiched between the second cover member 104 and the second supporting member 55 of the fixing unit 5b. In the present embodiment, the spring 80 and the cap portion 82 are sandwiched between the second cover member 104 and the second supporting member 55.

By being sandwiched between the second cover member 104 and the second supporting member 55, the spring 80 biases the second supporting member 55 in an attachment direction D12 by the elastic force (see FIG. 7). The attachment direction D12 is a direction opposite to a drawing direction D11 of the fixing unit 5b.

Furthermore, by the force that the second supporting member 55 receives from the spring 80 when the second cover member 104 is positioned at the closing position, the protrusion portions 551 are abutted against the lower supporting portions 12.

By the actions of the spring 80 and the protrusion portions 551, the fixing unit 5b is positioned in the first direction D1. It is noted that the first direction bias mechanism 8 may alternatively be attached to the second supporting member 55 of the fixing unit 5b.

### [Switch 50]

The image forming apparatus 10 includes a switch 50 which switches a state according to an operation with respect to the first cover member 103 (see FIG. 7 and FIG. 8).

By opening of the first cover member 103, the switch 50 electrically turns off a power feed line to the heater 51 of the heating unit Sa. On the other hand, by closing of the first cover member 103, the switch 50 electrically turns on the power feed line.

The first cover member 103 is opened for opening a part of the sheet conveying path 30. In the present embodiment, the first cover member 103 is opened to thus open the third conveying path 30c (see FIG. 1). The switch 50 is provided as a safety device that is used when the first cover member 103 is opened.

### [Configuration of Latch/Release Mechanism 6]

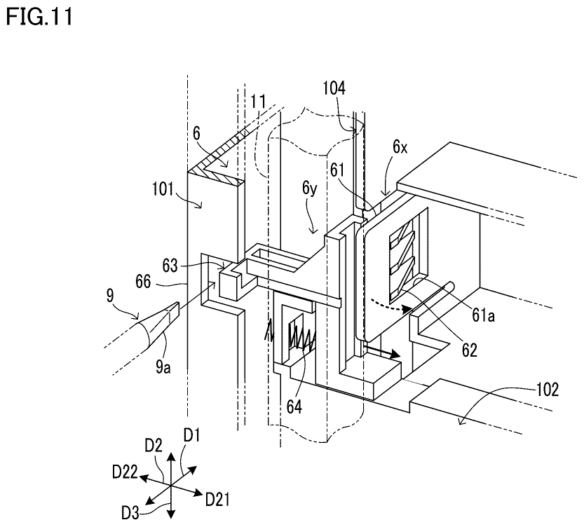

As described above, the latch/release mechanism 6 includes the latch mechanism 6x and the release mechanism 6y. The latch mechanism 6x latches the second cover member 104 at the closing position (see FIG. 7 and FIG. 11).

The release mechanism 6y releases the latch of the second cover member 104 by the latch mechanism 6x upon receiving an external force (see FIG. 8 and FIG. 10).

The release mechanism 6y is arranged at a position that can be accessed from the first opening 101 in the main body 1 (see FIG. 8). In other words, the release mechanism 6y can be accessed from outside the main body 1 only when the first cover member 103 is opened.

In the present embodiment, the release mechanism 6y can be accessed only when the power feed line to the heater 51 is electrically turned off by the switch 50.

In the present embodiment, the latch mechanism 6x includes an elastic latch portion 61 and an engagement portion 62 (see FIG. 7 to FIG. 11).

The elastic latch portion 61 can be elastically deformed from a latching shape for latching the second cover member 104 to a releasing shape for releasing the latch of the second cover member 104.

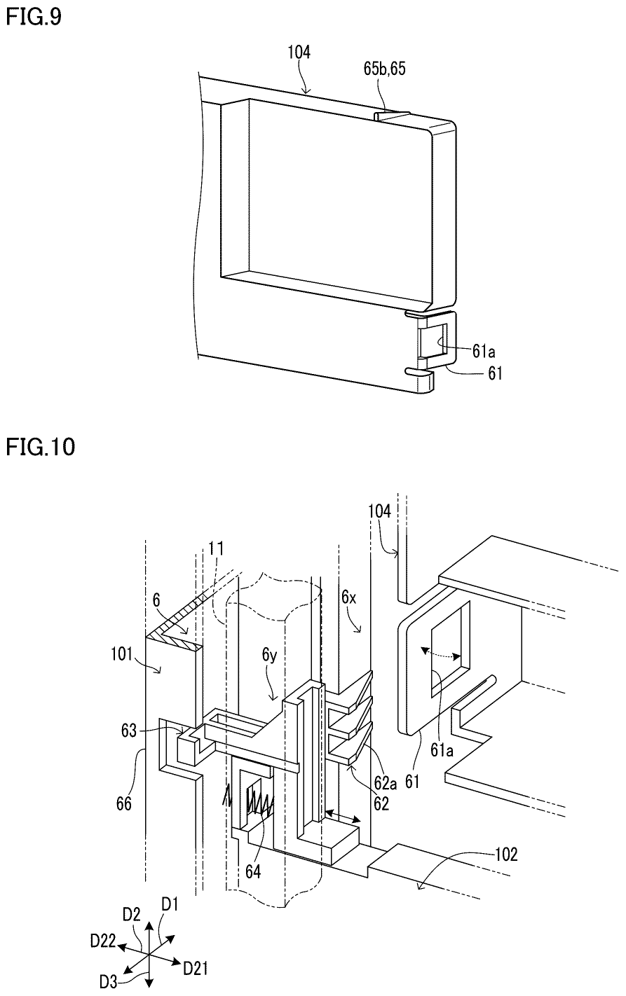

In the present embodiment, the elastic latch portion 61 is formed in the second cover member 104. The elastic latch portion 61 is of a plate shape that protrudes toward the inner side of the main body 1 from the second cover member 104 (see FIG. 7 and FIG. 9). The elastic latch portion 61 is formed with an opening 61a (see FIG. 9).

The engagement portion 62 engages with the elastic latch portion 61 by being inserted into the opening 61a of the elastic latch portion 61. In the present embodiment, the engagement portion 62 is provided at an edge portion of the second opening 102 in the main body 1 (see FIG. 7, FIG. 8, FIG. 10, and FIG. 11).

For example, as shown in FIG. 10, the engagement portion 62 includes tilted surfaces 62a that are tilted from the edge of the second opening 102 toward the inner side in the direction from the outer side toward the inner side of the main body 1. The elastic latch portion 61 and the engagement portion 62 constitute a so-called snap-fit.

When closing the second cover member 104, a tip end portion of the elastic latch portion 61 slides on the tilted surfaces 62a so that the elastic latch portion 61 is elastically deformed toward the inner side of the opening 61a. In addition, when the tip end portion of the elastic latch portion 61 passes beyond the engagement portion 62 toward the inner side of the second opening 102, the engagement portion 62 is inserted into the opening 61a of the elastic latch portion 61 (see FIG. 7 and FIG. 11).

The image forming apparatus 10 further includes a guide portion 65 which is provided at one or both of the edge portion of the second opening 102 in the main body 1 and the edge portion of the second cover member 104 (see FIG. 7 to FIG. 9).

When closing the second cover member 104, the guide portion 65 guides the second cover member 104 to a latching position at which the second cover member 104 is latched by the latch mechanism 6x. The latching position is also the closing position at which the second opening 102 is closed.

For example, the guide portion 65 protrudes from the edge portion of the second opening 102 in the main body 1. In this case, a top surface of the guide portion 65 is a surface that is tilted toward the inner side of the second opening 102 in the direction from the outer side of the main body 1 to the inner side.

Further, the guide portion 65 may also protrude from the edge portion of the second cover member 104. In this case, the top surface of the guide portion 65 is a surface that is tilted toward the inner side of the second cover member 104 in the direction from the outer surface side of the second cover member 104 toward the inner surface side.

When the second cover member 104 is opened, the second cover member 104 may be positionally deviated in the up-down direction or the lateral direction due to an allowance of the mechanism that supports the second cover member 104, or the like. When the second cover member 104 is closed, the guide portion 65 corrects the positional deviation of the second cover member 104.

For example, the guide portion 65 includes a lower guide portion 65a that is formed at a lower edge portion of the second opening 102 in the main body 1 or a lower edge portion of the second cover member 104 (see FIG. 8). In the example shown in FIG. 8, the lower guide portion 65a is formed to protrude from the lower edge portion of the second opening 102 in the main body 1.

In the present embodiment, the guide portion 65 further includes an upper guide portion 65b that is formed at an upper edge portion of the second opening 102 in the main body 1 or an upper edge portion of the second cover member 104 (see FIG. 9). In the example shown in FIG. 9, the upper guide portion 65b is formed to protrude from the upper edge portion of the second cover member 104.

The release mechanism 6y includes a movable member 63 and an elastic bias member 64 (see FIG. 7 to FIG. 11). The movable member 63 moves from a first position to a second position upon receiving an external force. FIG. 7, FIG. 10, and FIG. 11 each show a state where the movable member 63 is positioned at the first position. FIG. 8 shows a state where the movable member 63 is positioned at the second position.

In the present embodiment, the second position is a position on the first side D21 of the second direction D2 with respect to the first position. In the present embodiment, the restriction portion 11 is abutted against a part of the movable member 63 so as to restrict the movement of the movable member 63 toward the first side D21 beyond the second position.

The elastic bias member 64 elastically biases the movable member 63 from the second position side toward the first position. In the present embodiment, the elastic bias member 64 is a tension spring that biases the movable member 63 from the second position side toward the first position.

It is noted that a compression spring, a leaf spring, or the like may be adopted as the elastic bias member 64.

Upon receiving a force that is directed from the second side D22 toward the first side D21 in the second direction D2, the movable member 63 moves from the first position to the second position against a bias force of the elastic bias member 64. When moving from the first position to the second position, the movable member 63 is abutted against the elastic latch portion 61.

By biasing the elastic latch portion 61 when the movable member 63 moves from the first position to the second position, the movable member 63 causes the elastic latch portion 61 to be deformed from the latching shape to the releasing shape. In FIG. 7, the movable member 63 that has moved to the second position and the elastic latch portion 61 that has been deformed to the releasing shape are indicated by virtual lines (dash-dot-dot lines).

By the elastic latch portion 61 being deformed from the latching shape to the releasing shape by the bias force of the movable member 63, the engagement portion 62 comes off from the opening 61a of the elastic latch portion 61, and thus the latch of the second cover member 104 by the latch mechanism 6x is released.

In the present embodiment, when the latch of the second cover member 104 by the latch mechanism 6x is released, the first direction bias mechanism 8 causes the second cover member 104 to move from the closing position to the opening position side by the force of the spring 80 (see FIG. 10).

In the present embodiment, by performing an operation of opening the second cover member 104 and an operation of moving the movable member 63, the latch of the second cover member 104 by the latch mechanism 6x is released. Thus, it is possible to prevent the user from carelessly drawing out the fixing unit 5b from the main body 1.

The image forming apparatus 10 further includes an access limitation portion 66 (see FIG. 10 and FIG. 11). The access limitation portion 66 limits a size of an access path from the first opening 101 to a region on an opposite side of the second position side with respect to the movable member 63 in the main body 1.

Specifically, the access limitation portion 66 limits the access path to a size in which a finger cannot be inserted. The access limitation portion 66 forms the access path such that a tip end portion 9a of a stick-like portion in a tool 9 such as a screwdriver can be inserted (see FIG. 7, FIG. 8, and FIG. 11).

By rotating the tool 9 in a state where the tip end portion 9a of the tool 9 is inserted into the access path, the tool 9 transmits a force to the movable member 63 as a lever that uses the access limitation portion 66 as a fulcrum and the tip end portion 9a as a load (see FIG. 8).

The access limitation portion 66 prevents the user from carelessly operating the movable member 63 with a finger.

### Modified Example

In the image forming apparatus 10, the entire fixing device 5 may be capable of being drawn out from the main body 1 via the second opening 102.

In the image forming apparatus 10, the elastic latch portion 61 may be arranged at the edge portion of the second opening 102 in the main body 1. In this case, the engagement portion 62 is formed at the edge portion of the second cover member 104.

### Notes of Disclosure

Hereinafter, a general outline of the invention extracted from the embodiment described above will be noted. It is noted that the respective configurations and processing functions described in the notes below can be sorted and arbitrarily combined as appropriate.

### <Note 1>

An image forming apparatus, including:
a main body including a first opening and a second opening formed in a direction different from that of the first opening;
a sheet conveying path which is arranged in the main body and passes through a specific position inside the first opening;
a first cover member which is capable of opening and closing the first opening and is opened to thus open a part of the sheet conveying path;
a second cover member which is capable of opening and closing the second opening;
a fixing device which is arranged at the specific position in the main body, includes a heater and a fixing member which is heated by the heater and also heats a toner image formed on a sheet that passes through the specific position, and at least a part of which can be drawn out from the main body via the second opening;
a latch mechanism which latches the second cover member at a closing position; and
a release mechanism which is arranged at a position that can be accessed from the first opening in the main body and releases the latch of the second cover member by the latch mechanism upon receiving an external force.

### <Note 2>

The image forming apparatus according to note 1, including a switch which electrically turns off a power feed line to the heater by opening of the first cover member and electrically turns on the power feed line by closing of the first cover member.

### <Note 3>

The image forming apparatus according to note 1 or 2, in which
the latch mechanism includes an elastic latch portion which can be elastically deformed from a latching shape for latching the second cover member to a releasing shape for releasing the latch of the second cover member, and
the release mechanism includes a movable member which biases the elastic latch portion when moving from a first position to a second position upon receiving an external force, to thus cause the elastic latch portion to be deformed from the latching shape to the releasing shape.

### <Note 4>

The image forming apparatus according to note 3, including an elastic bias member which elastically biases the movable member from a side of a second position toward a first position.

### <Note 5>

The image forming apparatus according to note 3 or 4, including an access limitation portion which limits a size of an access path from the first opening to a region on an opposite side of a side of a second position with respect to the movable member in the main body.

### <Note 6>

The image forming apparatus according to any one of notes 1 to 5, including a guide portion which is provided at one or both of an edge portion of the second opening in the main body and an edge portion of the second cover member, and guides, when closing the second cover member, the second cover member to a latching position at which the second cover member is latched by the latch mechanism.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
a main body including a first opening and a second opening formed in a direction different from that of the first opening;
a sheet conveying path which is arranged in the main body and passes through a specific position inside the first opening;
a first cover member which is capable of opening and closing the first opening and is opened to thus open a part of the sheet conveying path;
a second cover member which is capable of opening and closing the second opening;
a fixing device which is arranged at the specific position in the main body, includes a heater and a fixing member which is heated by the heater and also heats a toner image formed on a sheet that passes through the specific position, and at least a part of which can be drawn out from the main body via the second opening;
a latch mechanism which latches the second cover member at a closing position; and
a release mechanism which is arranged at a position that can be accessed from the first opening in the main body and releases the latch of the second cover member by the latch mechanism upon receiving an external force.

2. The image forming apparatus according to claim 1, comprising:
a switch which electrically turns off a power feed line to the heater by opening of the first cover member and electrically turns on the power feed line by closing of the first cover member.

3. The image forming apparatus according to claim 1, wherein
the latch mechanism includes an elastic latch portion which can be elastically deformed from a latching shape for latching the second cover member to a releasing shape for releasing the latch of the second cover member, and
the release mechanism includes a movable member which biases the elastic latch portion when moving from a first position to a second position upon receiving an external force, to thus cause the elastic latch portion to be deformed from the latching shape to the releasing shape.

4. The image forming apparatus according to claim 3, comprising:
an elastic bias member which elastically biases the movable member from a side of the second position toward the first position.

5. The image forming apparatus according to claim 3, comprising:
an access limitation portion which limits a size of an access path from the first opening to a region on an opposite side of a side of the second position with respect to the movable member in the main body.

6. The image forming apparatus according to claim 1, comprising:
a guide portion which is provided at one or both of an edge portion of the second opening in the main body and an edge portion of the second cover member, and guides, when closing the second cover member, the second cover member to a latching position at which the second cover member is latched by the latch mechanism.
